(19) United States
(12) Patent Application Publication
(10) Pub. No.: US 2009/0014186 A1
(43) Pub. Date: Jan. 15, 2009

(54) Compact self contained removable firefighting unit

(76) Inventor: Jeff Collins, Boerne, TX (US)

Correspondence Address: Charles W. Hanor, 750 Rittiman Road, San Antonio, TX, 78209, US

(21) Appl. No.: 11/825,885

(22) Filed: Jul. 10, 2007

(51) Int. Cl. A62C 27/00

(52) U.S. Cl. 169/24; 169/30

(57) ABSTRACT

A system which is sufficiently compact and portable to be moved via skid support platform to a multi-wheel diesel-powered host containing active pump and roll capability with front and rear active hydraulics, such as a Bobcat Toolcat Turbo 5600. The system contains a water tank, generally 150 gallons, as well as built in foam tank. The system is wholly powered by the hydraulic system of the host vehicle powering a hydraulic motor on the system. The system hydraulic motor turns a serpentine belt at sufficient RPM's to power a water pump, air compressor and the compressed air foam system (CAFS) module. Using solely the power provided by the hydraulic motor, water is drawn from the tank, either used alone or mixed with foam at the percentage inputted by the user. Compressed air is added and the air alone, water alone or water/foam mixture is routed via adjustable valve to either the 1 inch firefighters hose or the rigid waterway ending in an adjustable, movable nozzle attached to the cab roof of the host.

### FIELD OF THE INVENTION

This invention relates to the field of firefighting, or more particularly the field of wildland and brush firefighting in areas requiring specialized, portable off-road equipment to gain access to the involved area. More particularly, this invention provides a compact self contained removable firefighting unit using a water/foam fire fighting system which is able to access areas that traditional larger firefighting vehicles are unable to access.

### BACKGROUND OF THE INVENTION

There are many situations when it would be helpful to have a compact, portable firefighting system readily available and able to venture where large, full-scale fire-fighting vehicles and pick-up trucks are unable to go. This system would be extremely helpful in rural areas where smaller, or volunteer fire departments need a system to take water and foam directly to the fire, despite the fire being off-road or in an inaccessible brush or forested area.

This portable, compact system would serve as an adjunct to the fire fighters who typically are required to fight wildland and brush fires on the ground with hand tools which is both labor intensive, costly and dangerous.

The ability to take foam directly to a fire has multiple benefits. The usefulness of foam in firefighting has long been recognized. Foam allows firefighters to blanket an area retarding combustion, or suffocating a fire already present. Additionally, depending on the % concentration of the foam, it is able to “stick” to potential combustibles, including brush and trees.

### BRIEF SUMMARY OF THE INVENTION

This invention relates to a multi-functional hydraulically-driven compressed air foam system (CAFS) module built into a system which contains a front remote-control nozzle and rear hose reel for wildland and brush firefighting in areas typically difficult to reach with conventional wildland and brush fire apparatus.

The current invention is designed for attachment via removable skid support platform to a multi-wheel diesel-powered host containing active pump and roll capability with front and rear active hydraulics, such as a Bobcat Toolcat Turbo 5600.

The primary object of this system is to allow a one- or two-man firefighting team to easily gain access to areas of difficult terrain for safe and efficient firefighting. The system requires minimal manpower and equipment to work these difficult areas.

The current invention is built on a removable skid support platform that contains a front-mounted, remote-control nozzle; rigid water supply conduit and support mounted above the unit and over the host's cab; equipment storage boxes; water tank with a built-in foam cell; a hose reel and hose; and a CAFS module containing a water pump, hydraulic motor and rotary screw air compressor. One of the advantages of this design is that a separate combustion engine is not required to power the water pump, air compressor or CAFS unit as everything is driven by the hydraulic motor. This fact helps keep the system compact and light enough for use on a multi-wheel diesel-powered host containing active pump and roll capability with front and rear active hydraulics, such as a Bobcat Toolcat Turbo 5600. Additionally, the lack of combustion engines adds to the safety of the system as a combustible fluid such as gasoline is not required to power the unit separate and apart from the diesel motor which powers the hydraulic system on the host vehicle.

The current invention's remote-control nozzle is controlled by a hand-held unit typically known as a “joy stick” inside the host's cab. The joy stick is either wired to the invention's electronic communicator or controlled by radio-operated wireless technology. Liquid or foam is supplied to the front remote-control nozzle through a series of rigid water supply conduits and supports mounted above the system and the host's cab.

Although the host's diesel engine provides power, power could also be provided by any other number of sources including but not limited to fuel battery packs, natural or propane gas, electric or gasoline motor, or any combination of these sources if necessary or desired by the end user.

Water may be drawn from the attached tank, generally 150 gallons or from another external source such as a swimming pool, lake, stream or river. The, water, foam or water/foam may be discharged via either the attached 150 ft. forestry hose or remote control cab mounted nozzle.

### PRIOR ART

Unlike the prior art, the current invention is on a hydraulically-driven host, which does not require an air compressor to provide brakes for the host, leaving the air compressor to provide 100% capacity toward fire protection or other use, such as operating firefighting or rescue tools or equipment.

A disadvantage of the Adamson system described in prior art U.S. Pat. No. 6,973,975 to Anderson et al. is that the prior art's systems' pump and air compressor are each powered by separate, auxiliary gas or diesel engines. The advantage of the hydraulically-powered CAFS module in the current invention is the elimination of a separate auxiliary motor. In the current invention, the air compressor and pump are driven by a single hydraulic motor that is powered by the host's motor.

Another distinct advantage of the current invention is the significant difference in weight of the entire unit, due to the use of the hydraulic motor rather than the separate auxiliary motors of the prior art. Typical gas or diesel motors such as those used in the prior art take away a significant amount of usable gross vehicle weight (GVW). The hydraulic motor in the current invention requires only a fraction of the GVW, which allows the user to carry more water, foam or firefighting equipment.

Unlike the Adamson prior art, the current invention also contains a rigid pre-plumbed waterway mounted above the unit and the host's cab which supplies water or foam to the front remote-control nozzle. In addition, the nozzle is operated from the protection of the host's controlled-temperature cab, eliminating the need for the crew to move outside of the host cab once the firefighting efforts begin. The hose also can be operated from inside of the host cab by one of the crew members rather than on foot, as with most other systems.

### DESCRIPTION OF THE DRAWINGS

FIG. 1 illustrates the driver's side perspective of the current invention mounted on a typical host with a multiuse attachment on the front of host.

FIG. 2 illustrates the view from the top of the current invention showing the placement of the system components, rigid pre-plumbed waterway and remote-control nozzle in relation to the host with a multiuse attachment on the front of host.

FIG. 3 illustrates a view from the top of the CAFS module in the current invention showing placement of the individual components that make up the module.

FIG. 4 illustrates the driver's side perspective of the CAFS module in the current invention showing placement of the individual components that make up the module.

FIG. 5 illustrates, from the rear view of the host, the CAFS module and controls, the hose reel and the host hydraulic lines which power the CAFS module's hydraulic motor.

FIG. 6 illustrates the passenger side view of the CAFS module and the connections between the CAFS module and the system's water tank and foam tank.

### DETAILED DESCRIPTION OF THE INVENTION

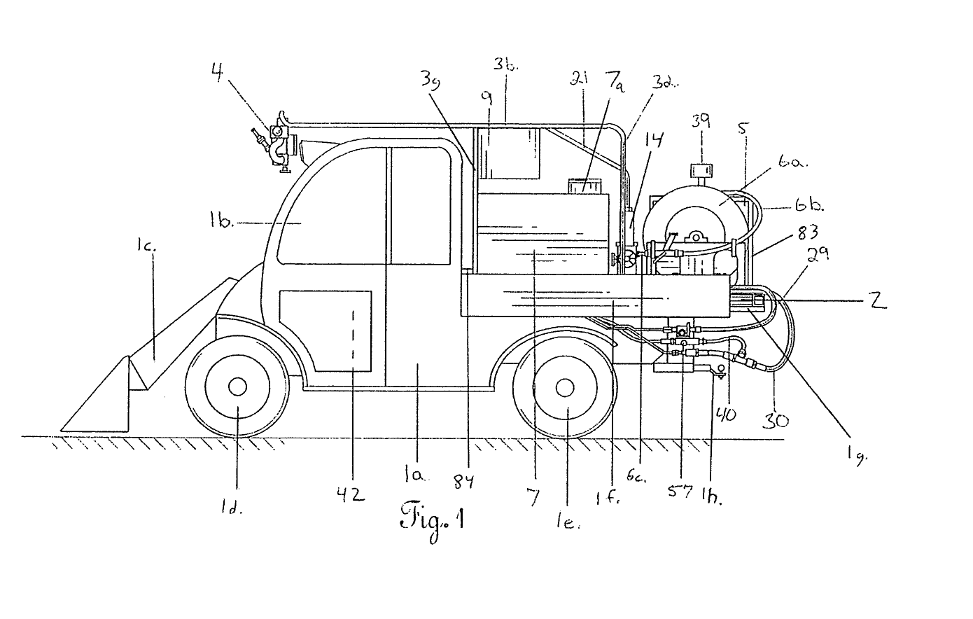

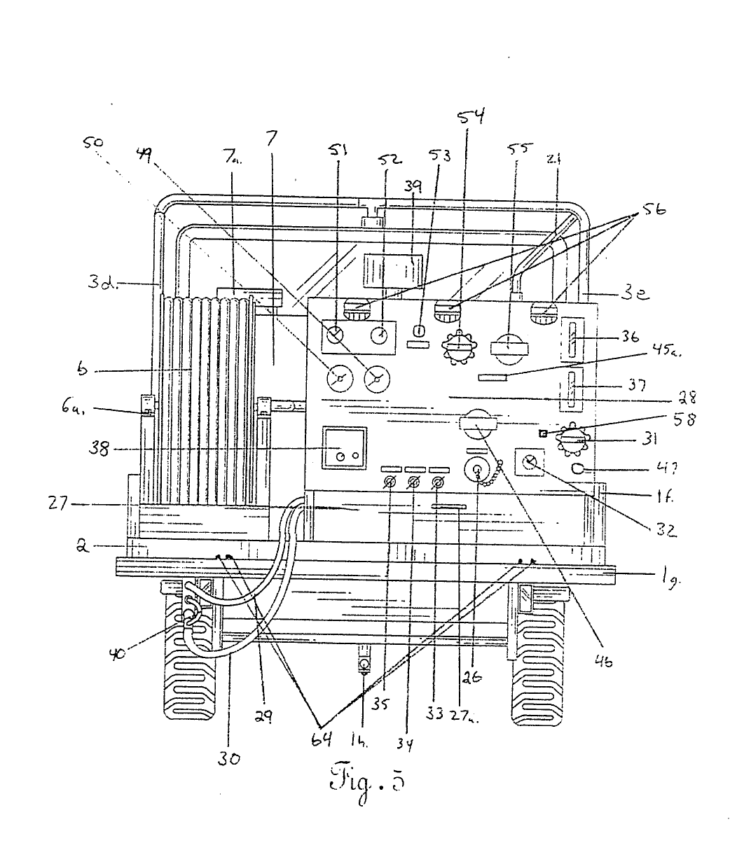

Referring now to FIG. 1, the illustration is the driver's side perspective of the system on a compact host vehicle 1. The compact host vehicle 1 is typically a multipurpose compact vehicle that can be easily maneuvered in tight spaces that is usually equipped with an attachment 1c located in front of the front wheels 1d, trailer hitch 1h behind the rear wheels 1e and hydraulic connections under the bed 1f on the driver's side. The compressed air foam system CAFS unit 5 stabilized by a steel frame 83, water tank 7, and metal reel 6a are attached to a skid support platform 2 comprised of aluminum tubing and sheets. The skid support platform 2 fits within bed 1f, spanning the width of the bed 1f and extending onto the tailgate 1g. The easily removable skid support platform 2 is mounted onto the bed 1f and tailgate 1g of host 1 with two steel bolts 64 (visible on FIG. 5) on the left rear and two steel bolts 64 on the right rear of the skid support platform. The skid support platform 2 is further attached to the bed 1f of host 1 by inserting the front of skid support platform 2 proximal to the drivers cab 1b under a lip 84 bolted to bed 1f of the host vehicle with bolts 64.

The polyurethane water tank 7, mounted to skid support platform 2, is shown immediately behind the driver's cab 1b of host vehicle 1 and spans the width of the bed 1f. The water tank refill conduit 7a is located on the rear portion of the water tank 7 on the driver's side. This conduit allows the water tank to be refilled by hose. A personal protective equipment storage box 9 spans the width of the water tank and is mounted over the water tank 7. A large metal hose reel 6a apparatus is mounted on the skid platform 2 located on the driver's side behind the water tank 7 extending to the rear of host 1 and may include 150 feet of forestry hose 6b with nozzle attached 6c. The CAFS unit 5 and its steel frame 83, is mounted on the passenger side of host 1 next to the metal hose reel 6a.

Also mounted on the skid support platform 2 are steel tubular supports 3 that support an adjustable remote control nozzle 4 located above the driver's cab 1b. The tubular supports 3 are mounted to the skid support platform 2 at the front driver's side corner of the bed 1f just behind the lip 84 by vertical support 3g, and on the driver's side in the middle of the bed 1f by vertical support 3d. Each tubular support has a counterpart on the passenger's side (not shown) with 3h in the front and 3e in the middle of the bed 1f. Mounted parallel to the ground along the driver's side, tubular support 3b extends over the driver's cab 1b and is welded to the supports 3g and 3d. On the passenger side, support 3a is welded to vertical support columns 3h and 3e (not shown) and extends across the passenger's side cab. Tubular support 3c is located across and in front of the cab 1b with nozzle 4 mounted in the center. The nozzle 4 is controlled by a trigger controlled wired joystick 42 mounted in the operator cab 1b.

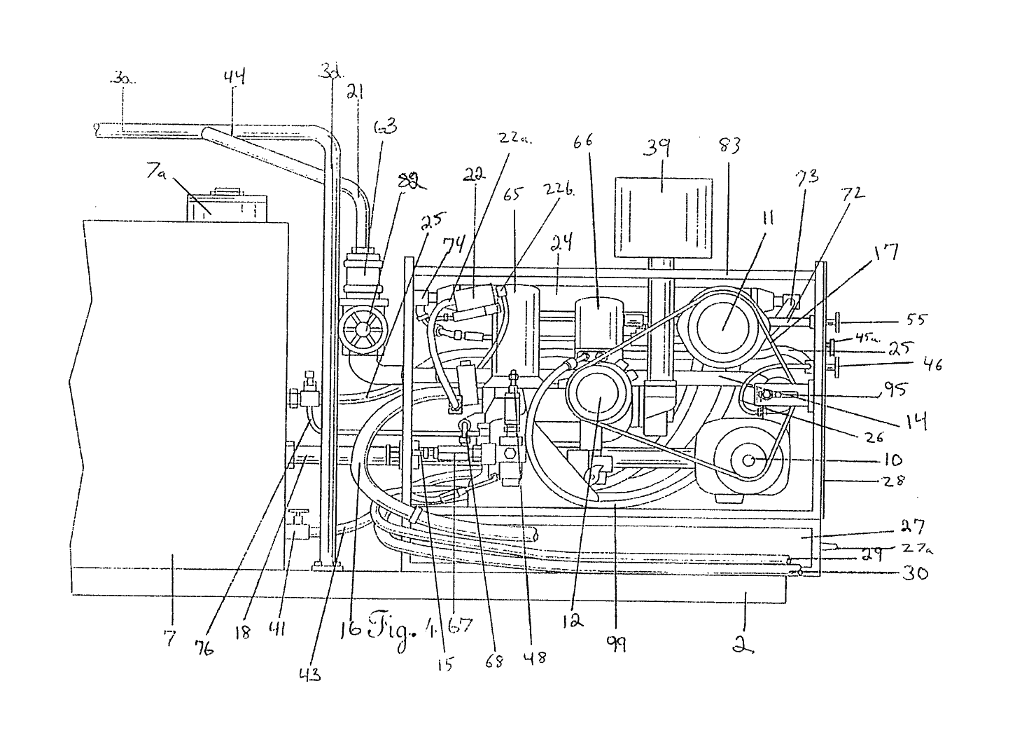

The host 1 hydraulic hookup 57 is located on the driver's side under the bed 1f. The flexible hydraulic hose 29 transports hydraulic oil from the host 1 to the hydraulic motor 11 (shown in FIG. 4) and is then returned to the hydraulic hookup 57 via flexible hydraulic hose 30. Additionally a flexible auxiliary return hose 40 connects flexible hydraulic return hose 30 to hydraulic hookup 57. All connections to the hydraulic hookup 57 are through quick connect couplings.

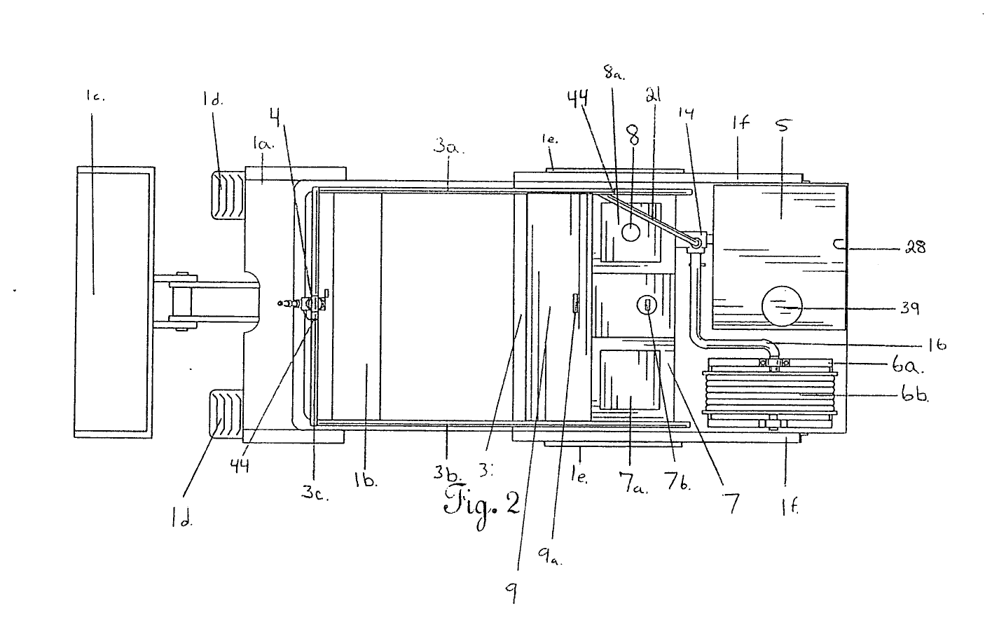

Turning now to FIG. 2 of the CAFS unit 5, there is shown the adjustable remote control nozzle 4 attached to the rigid water supply conduit and support 3c which provides either water or a water/foam mixture to the nozzle. Supports 3c and 3a serve as conduits for the water/foam mixture to reach the remote controlled nozzle 4. Support 3c consists of multiple parts with segment 3c spanning the width of cab 1b and located above it. Support 3c is connected on the driver side by support 3b that runs along top of the driver side to approximately the middle of the bed 1f (shown in FIG. 1). Support conduit 3c is connected on the passenger side through support conduit 3b that runs the length of the passenger side to approximately the middle of bed 1f. The joint between support 3c and 3b is formed by utilizing two 90 degree curved elbow pieces. One curved elbow is joined to support 3b with the open end facing up. The second curved elbow piece connects to the first elbow and connects with support 3c. The result is an upward 90 degree curve that adds to structural stability of support 3c. The joint between 3c and 3a is formed in the same manner. Steel tubular support 3i runs parallel to support conduit 3c and is located directly behind the cab 1b. A rigid “T” joint is formed by support 3i, 3b and 3g on the driver's side and another “T” joint is formed on the passenger side between support 3i, 3a, and 3h. Flexible water/foam hose 21 is attached to pump discharge pipe 14 through a clamp and is also attached to support conduit 3a through a clamp. There are two welded steel caps 44 which close support 3a to prevent the backflow of water or foam. There is one cap 44 immediately posterior to the joint of support 3a and flexible water/foam hose. There is another cap inside support 3c immediately past the remote controlled nozzle 4. The result is a water/foam conduit allowing water/foam to flow from the juncture of support 3a and flexible water/foam hose 21 to the remote controlled nozzle 4.

A personal protective equipment storage box 9 with latch 9a is mounted above the water tank 7 and is directly behind the cab 1b. A lid 7a that can be lifted manually is located on the driver's side on top of the water tank 7 that can be used to fill the water tank 7 with water. In the middle of the water tank 7 is a removable panel with a latch 7b. The foam tank 8 is formed on the interior passenger side of the water tank 7 and has a refill conduit 8a for the foam tank located adjacent to lid 7a. The steel hose reel apparatus 6a is attached to the skid support platform system 2 on the rear driver side immediately proximal to the CAFS unit 5. The CAFS unit 5 is immediately adjacent to the hose reel 6a and is to the rear of the system, attached to the skid support platform 2 on the passenger side of the system. The flexible hose reel discharge line 16 is connected to the steel reel assembly 6a and runs between the steel hose reel 6a and the CAFS unit 5 before curving 90 degrees behind the CAFS unit 5 and between the water tank 7. The flexible hose reel discharge line 16 provides either water or a water/foam mix to the hose 6b.

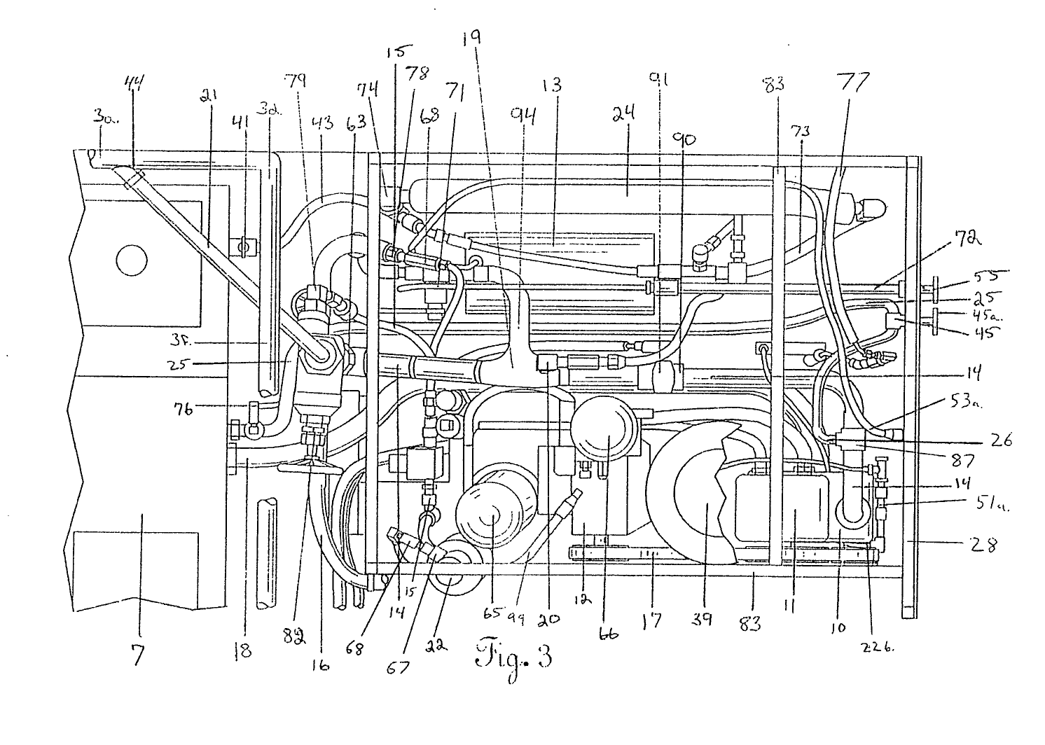

FIG. 3 is a detailed topdown view of the system including the CAFS unit 5 and its various components. The CAFS unit 5 is contained within a steel frame 83 which is bolted onto the aluminum skid support platform 2.

The self-contained system contains the foam proportioner 13, water pump 10, hydraulic motor 11 and air compressor 12. The water pump 10 suctions water from the water tank 7 through a fixed pump intake pipe 18. Pump intake pipe 18 emerges near the bottom center of the water tank 7, makes a 90° turn towards the passenger side of host 1, then makes another 90° turn and runs toward the rear of host 1. The pump intake pipe 18 runs to the passenger side of water pump 10 which is located at the bottom driver's side of CAFS unit 5. Water from the tank flows through the pump intake pipe 18 to the water pump 10 and discharges through the pump discharge pipe 14 located on the top of the water pump 10 and is attached to the control panel 28 by a U” bracket (not shown). The pump discharge pipe 14 extends perpendicular up out of the water pump 10 before turning toward the passenger-side of the host vehicle 1 at a 90° angle. The pump discharge pipe 14 continues briefly before turning 90° toward the front of the host 1. The section of pump discharge pipe 14 between the 90° turns noted above 87 is welded to the curved elbow shaped turn sections. Connected horizontally to the side of pipe 87 is a “T” junction that is connected to auxiliary tank fill hose 26. Auxiliary tank fill hose begins on the control panel 28 and extends through the control panel 28 and enters valve assembly 45. The jet primer valve 32 (shown on FIG. 5) is utilized to help create a suction that draws water from the outside source into the auxiliary tank fill hose 26. When tank fill valve 45a is turned, it controls the valve 45 which either allows water to continue through auxiliary tank fill hose 26 or enter tank fill line 25. Auxiliary tank fill hose 26 may be connected to a secondary source of water such as a pond through use of an external hose connected to the auxiliary tank fill hose 26. The suction created by the water pump allows water to flow through auxiliary tank fill hose 26 and depending on how the valve 45a is turned, it can either be pulled through the auxiliary tank fill line 26, through the “T” junction 87 and into pump discharge pipe 14 or the water can be pulled into the auxiliary tank fill hose 26, into the valve assembly 45, pulled through tank fill hose 25 and finally be deposited in the water tank 7.

A brass “T” junction 90 is connected to the pump discharge pipe 14 immediately after the pump discharge pipe 14 makes the 90° turn towards the front of the host 1. The brass “T” junction 90 has a section perpendicular to the horizontal piping attached to the pump discharge pipe 14. Inserted into the perpendicular section of “T” junction 90 is a paddlewheel flowmeter 91 to which an electrical line is attached leading to the foam proportioner 13. The purpose of flowmeter 91 is to measure the water flow and send a signal to the motor driver control of the foam proportioner 13 thereby controlling foam output.

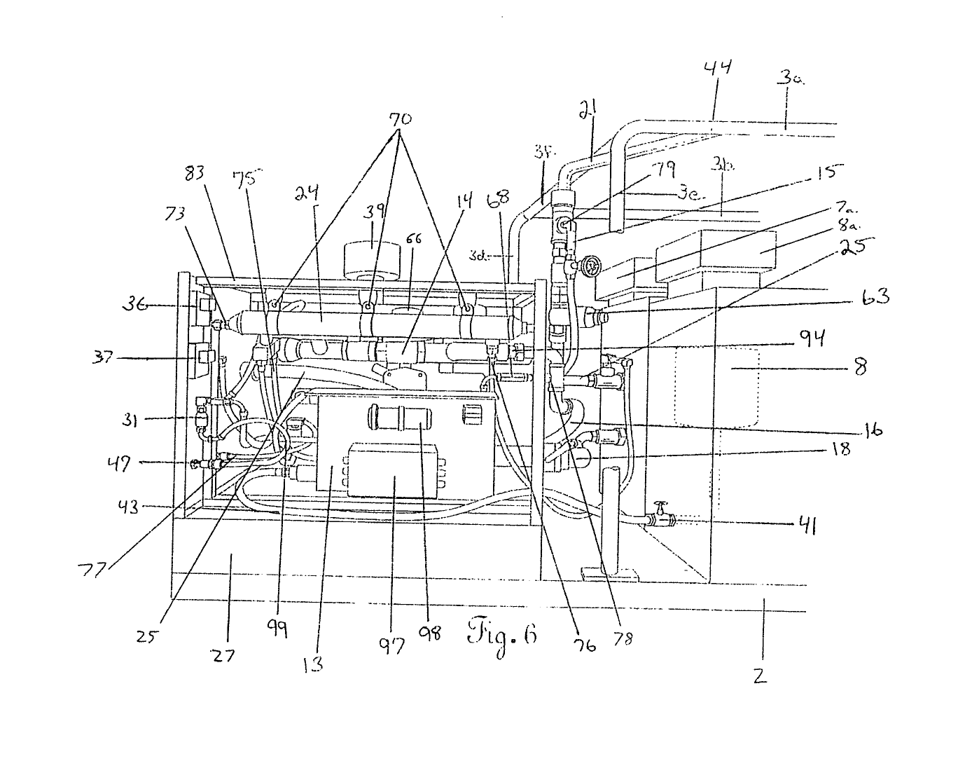

Pump discharge pipe 14 continues through the “T” junction 90 where it is connected to “T” junction 19. Pump discharge pipe 14 continues thru “T” junction 19, while the perpendicular portion of “T” junction 19 lies horizontally facing the passenger side of host 1 and is further connected to an elbow shaped pump-to-hose discharge pipe 94 that makes a 90° turn towards the front of host 1. Pump-to-hose discharge pipe 94 continues briefly before making a 90°0 turn down approximately 6″ and then turning 90° toward the driver's side of host 1. Attached to pump-to-hose discharge pipe 94 via clamp is the flexible hose reel discharge line 16 which leads to hose reel 6a and forestry hose 6b. Air discharge line 68 enters pump-to-hose discharge line 94 through brass inlet 78 (shown on FIG. 6) providing air to pressurize the mixture. Prior to the 90 degree downward turn of pump-to-hose discharge pipe 94 is the hose reel water valve 71 that when opened allows water to flow to the hose reel discharge line 16. A push pull rod 72, connects to hose reel water valve and extends the length of CAFS unit 5 to control panel 28 located on the rear of the CAFS unit 5. The push/pull rod 72 consists of two rods connected by a uniflex joint and is opened when the hose reel water handle 55, located on the control panel 28, is pulled.

Inserted into the top of “T” junction 19 is a foam injector port 20. The foam injector port is connected to a hose with a 1-way check valve leading from the CAFS unit 5. Pump discharge pipe 14 continues through “T” junction 19 via a 1½″ pipe outlet and continues toward the front of the host vehicle 1 exiting the metal frame 83 where the pump discharge line makes a 90° turn vertically where it is connected to a manual gate valve 82 which opens/closes pump discharge pipe 14. Immediately past the manual gate valve 82, pump discharge pipe 14 continues briefly where it is then screwed into electric motor valve 63 which opens/closes the valve based on input from the trigger switch control within the cab of host 1. The electric motor valve 63 allows the water, foam or water/foam mixture to continue through pump discharge line 14 on to flexible water/foam hose 21 which continues straight up before making a 45° turn to the front of the host 1 and connecting via clamp to the horizontal section of support conduit 3a which leads to remote control nozzle 4. Inlet 79 is where the flexible air discharge hose 15 joins pump discharge pipe 14 immediately past electric motor valve 63. A rigid manual shut off valve 15a connects the flexible air discharge hose 15 with inlet 79. The air discharge hose 15 originates on the bottom end of the air compressor 12 and provides air pressure to the water/foam mixture exiting the unit through the adjustable remote control nozzle 4.

The water line 76 (shown on FIG. 6) starts from the heat exchanger 24 and returns back into the water pump 10 via an inlet into the tank fill line 25 near the water tank 7. The oil line 73 travels from the air compressor 12 into the heat exchanger from the rear of host 1 for cooling from the air compressor 12 then exits at the opposite end of the heat exchanger near the water tank 7 as oil line 74, returning the cooled oil to an inlet on the air compressor. The foam drain line 77 exits on the passenger side of CAFS unit 5. The compressor warning light 53 (shown on FIG. 4) is connected to the flexible compressor warning line 53a.

FIG. 4 is a view of the CAFS unit 5 from the driver's side of Host 1 with the hose reel 6 removed to increase the viewable area. Extending up over the CAFS unit 5 is the air intake with filter 39 which provides filtered air to the air compressor unit 12. Also shown are the oil filter 65 and air separator 66, both attached to the top portion of the air compressor unit 12. The flexible hydraulic hose 29, which is connected to the host hydraulic hookup 57 (shown on FIG. 1), provides hydraulic fluid under pressure to the hydraulic motor 11, shown at the driver's side rear of the host unit 1 above the water pump 10. The flexible hydraulic return hose 30 exits the hydraulic motor and returns to the host vehicle 1 through connection at the host hydraulic hookup 57 at the drivers side rear of the host unit 1. The auxiliary hydraulic return line 40 (shown on FIG. 1) is connected to both the hydraulic return line 30 and the host hydraulic hookup 57. The hydraulic fluid travels from the host hydraulic hookup 57 through the hydraulic line 29 to the hydraulic motor 11. Pressure from the hydraulic fluid provided through the hydraulic line 29 turns the hydraulic motor at approximately 3800 rpm's. This force is used to rotate the serpentine belt 17 which powers the air compressor 12 and the water pump 10. Towards the rear of the CAFS unit and bracketed to the steel support 83 of the CAFS unit 5 is the serpentine belt tensioner 95 which moves a gear forward and back on a railing with a screw to hold the gear in place, thereby allowing the notched serpentine belt 17 to be tightened or loosened as needed. At the bottom of the CAFS unit 5 and integrated as part of the skid platform support 2 is the hand tool equipment box 27 which slides open to the rear of the system immediately under the control panel 28. Immediately below the equipment box 27 is the aluminum skid support platform 2.

The main air discharge valve 48 is located immediately next to air compressor 12 on the driver's side and supplies air to main air discharge pipe 67. From main air discharge pipe 67 the air travels to air discharge hoses 15 and 68. Air discharge hose 15 leads to pump discharge pipe 14 via inlet 79 and air discharge pipe 68 leads to hose reel 16 via inlet 78. To aid in better foam production, a pressure balancer 22 connected between air compressor 12 via line 22c (not shown) and balancing lines 22a and line 22b. Line 22a measures the water pressure psi coming from the pump discharge line 14 and measures through a valve located on pipe 87 (not shown). Line 22b leads to the fixed/auto air control coupling 51a (shown on FIG. 3) which attaches to fixed/auto air control 51 located on control panel 28 (shown on FIG. 5) and when activated allows the balancer 22 to balance the pressure from the water discharge pipe 14 and the main air valve 48 through line 22c (not shown). The equalization of air pressure from the air compressor and water pressure ensures better foam production. The auxiliary discharge air supply originates from the air compressor 12 and travels through a flexible hose 99 that connects to the auxiliary air discharge valve 31 and subsequently to the auxiliary air discharge 47 located on the control panel of the CAFS unit 5 (shown on FIG. 6).

Immediately posterior to water tank 7 is the auxiliary tank fill line 25 with the water line 76 returning water from the heat exchanger 24 back to the water tank being accomplished thru an inlet into the auxiliary tank fill line 25. The pump intake pipe 18 is located lower on the water tank 7 than the auxiliary tank fill line 25 is.

Referring to FIG. 5, this is a view from the rear of the CAFS unit 5 and host 1. Indicated on the drawing is the control panel 28 into which holes have been drilled for various gauges, switches, inlets and ports. Beginning on the driver side, top of panel 28 is the fixed air auto switch 51 and immediately next to it is run/unload air fixed pump control 52. Along the upper edge of panel 28 are 3 fixed panel lights 56 controlled by the panel light switch 58. Immediately underneath the fixed air auto switch 51 is the master water pressure gauge 50 and immediately underneath the run/unload air fixed pump control 52 is the master air pressure gauge 49. Below these 2 gauges is the foam proportioner % value control 38 which allows the foam to be turned on/off as well as controlling the foam output to between 0.01% and 1%. The compressor warning light 53 is to the immediate passenger side of the run/unload air fixed pump control 51. The hose reel air switch 54 is near the center/top of the control panel 28 and is operated by turning the knob counter-clockwise to open. To the immediate passenger side of the hose reel air switch 54 is the hose reel water handle 55 which operates via pulling to allow water to the hose reel 16 and pushing to stop the flow of water. Along the far upper passenger side corner of the control panel 28 is the LED water level indicator 36 and immediately below it the LED foam level indicator 37. Towards the bottom passenger side corner of panel 28 is the auxiliary air valve 31 and an auxiliary air discharge port 47. The tank to pump handle 46 is located in the middle of the control panel 28 is pushed to activate and pulled to close; it operates the main intake pipe to allow water to flow from water tank 7 to water pump 10. Immediately below is the auxiliary tank fill 26 a 1½″ pipe to the tank, capped with brass cap chained to the unit. To the immediate passenger side of foam proportioner % value control 38 are three drain valves listed from driver side to passenger side: cooler drain valve 35, manifold drain valve 33 and pump drain valve 34. Also on control panel 28 is the jet primer valve 32 used to pull water into pump for refilling or for spraying and is located in between the auxiliary discharge port 47 and the auxiliary tank fill 26.

The auxiliary discharge port 47 can be used with proper attachments to power tools that require compressed air such as rescue and impact tools. The system is controlled through shutting off water discharge through manual gate valve 82 or electronic motor valve 63 and hose-to-reel valve 55. Water is still able to run through the heat exchanger to cool the system down and returns to the water tank via water line 76.

Immediately below the control panel 28 and extending underneath CAFS unit 5, attached to skid platform 2 is a tool drawer 27 with handle 27a. Four bolts 64 affixing the skid support platform 2 to the bed of host 1 are screwed into the back rear of the host vehicle 1.

Looking at FIG. 6, the foam proportioner unit 13, secured to the passenger side of the CAFS unit 5, suctions foam from the foam tank 8 through a clear tube 43. The CAFS unit 5 uses a proportioner 13 that is mounted on the skid platform 2 and is used to control the water to foam ratio. By adjusting the proportion 13 the operator can optimize the amount of water used to create the foam spray that is used to put out fires. Visible on the foam proportioner unit 13 are the electronics for the proportioner 97 and the foam proportioner capacitor 98, both secured to the foam proportioner 13 itself. The foam from the tank 8 passes through a valve 41 with strainer immediately proximal to the foam tank 8 with polytube 43 attached to said valve via NST connection.

The heat exchanger 24 is attached to the top, passenger side of the CAFS unit 5 wherein it receives oil from the air compressor 12 via oil line 73 and cools it prior to the oil being returned to the air compressor 12 via oil line 74 (shown on FIG. 4). There are three brackets 70 used to attach the heat exchanger to the top of CAFS unit 5. A water hose 75 is the water input into the heat exchanger 24 directly from the water pump 10. Hose 76 emerges from the heat exchanger 24 at the opposite end of the input hose 75, and returns the water to the water tank 7 via an inlet located on tank fill hose 25 just prior to its entrance into water tank 7. Connected to the assembly along with input hose 75 is a drain hose 77 that allows water to drain from the system and exit through drain valve 33.

Hose 99 connects auxiliary air input 47 to auxiliary air valve 31. Immediately posterior to where water conduit 21 intersects and is welded to rigid water supply conduit and support 3a is a metal cap preventing backflow 44 of water through the rigid water supply conduit and support 3a.

The system operates as follows. The system is wholly powered by the hydraulic system of the host vehicle powering a hydraulic motor on the system. The system hydraulic motor turns a serpentine belt at sufficient RPM's to power a liquid pump, air compressor and the Compressed Air Foam System (CAFS) module. Using solely the power provided by the hydraulic motor, water or other liquid is drawn from the tank, either used alone or mixed with foam at the percentage inputted by the user. Compressed air is added and the air alone, liquid alone or water/foam mixture is routed via adjustable valve to either the 1 inch forestry hose or the rigid waterway ending in an adjustable, movable nozzle attached to the cab roof of the host. The system could also be used to spray chemicals such as insecticides, herbicides, fungicides, algaecides, fertilizers or other liquid solution. The typical liquid is water but other suitable liquids might be used. The type of spray can also be varied and controlled by the type of nozzle used.

The System can be easily removed from the vehicle by removing stainless steel bolts 64 attaching the skid support platform 2 to the host vehicles bed 1. Additionally, there is a metal lip 84 bolted to the bed of host vehicle immediately behind the drivers compartment. The skid support platform 2 of the system fit under this lip in addition to be bolted to the host vehicle. The hydraulic tubing, 29 and 30 must also be disconnected from the hydraulic hookup 57 of the host vehicle. Due to the weight of the system, a forklift or hoist may required to remove it from the host vehicle. However, after removal, the system may be quickly placed onto another host, bolted to the bed, hydraulic lines hooked up and the system is ready for use.

Before concluding, it is to be understood that the terminology employed in this application is for the purpose of describing particular embodiments. Unless the context clearly demonstrates otherwise, it is not intended to be limiting. In this specification and the appended claims, the singular forms “a,” “an” and “the” include plural references unless the context clearly dictates otherwise. Conversely, it is contemplated that the claims may be drafted to exclude any optional element or be further limited using exclusive terminology as “solely,” “only” and the like in connection with the recitation of claim elements or by use of a “negative” limitation. It is also contemplated that any optional feature of the inventive variations described herein may be set forth and claimed independently, or in combination with any one or more of the features described herein.

Although the foregoing specific details describe various embodiments of the invention, persons reasonably skilled in the art will recognize that various changes may be made in the details of the apparatus of this invention without departing from the spirit and scope of the invention as defined in the appended claims. Therefore, it should be understood that, unless otherwise specified, this invention is not to be limited to the specific details shown and described herein.

I claim;

1) A compact self contained removable system with a compressed air foam system unit for removable mounting on the rear of a multiple purpose compact host vehicle comprising:
a skid mountable platform for removably connecting on the rear of a multiple purpose compact host vehicle;
a liquid reservoir and a foaming agent reservoir mounted on the platform;
means connecting said reservoirs to a motor driven pump mounted on the platform and driven by a motor mounted on the platform;
a foam generator connected to said pump;
a remotely operated nozzle connected to the pump and mounted on a support extending from the platform to direct a spray away from the multiple purpose compact host vehicle for selectively delivering foam or liquid to a desired location away from the multiple purpose compact host vehicle;
a remote control device for mounting for access by an operator within the cab of the multiple purpose compact host vehicle for controlling and operating the remotely operated nozzle to selectively direct the remotely operated nozzle to a desired location away from the vehicle to output foam or liquid.

2) The compact self contained removable system as claimed in claim 1 wherein:
a foaming agent reservoir is mounted in the liquid reservoir.

3) The compact self contained removable system as claimed in claim 1 further comprising:
a manual hose reel with manual on/off control mounted on the system and connected to the pump for manually delivering foam or water via the hose nozzle;

4) The compact self contained removable system as claimed in claim 1 wherein:
said system is self contained and compact for releasably installing within the bed of the compact host vehicle.

5) The compact self contained removable system as claimed in claim 1 wherein;
a compact self contained removable system is powered by the compact host vehicle.

6) The compact self contained removable system as claimed in claim 1 wherein:
a compact self contained removable system is powered by hydraulic fluid under pressure from the compact host vehicle.

7) The compact self contained removable system as claimed in claim 1 whereby remote control device is included and comprises:
indicators and controls that allow an operator to monitor and control the compact self contained removable system within the compact host vehicle.

8) The compact self contained removable system as claimed in claim 1 further comprising:
valves and controls for allowing the operator to choose liquid only, a liquid/foam mixture only be delivered though the nozzle.

9) The compact self contained removable system as claimed in claim 1 wherein:
said compact self contained removable system contains a control to allow the operator to choose between directing the water/foam/air mixture to the remotely operated nozzle or the manually operated firefighting hose.

10) The compact self contained removable system as claimed in claim 1 wherein:
a compact self contained removable system is mounted on a skid support platform so that it can be readily releasable mounted and removed from the compact host vehicle when it is desired to use the compact host vehicle for different functions.

11) A method of removable mounting and operating a compact self contained removable system with a compressed air foam system unit on the rear of a multiple purpose compact host vehicle comprising the steps of:
removably connecting a self contained skid mountable platform including a compressed air foam system on the rear of a multiple purpose compact host vehicle;
connecting the compact self contained removable system to the power system of the compact host vehicle to provide power to the compact self contained removable system so the compact self contained removable system is powered by the compact host vehicle.

12) The method of claim 11, further comprising the steps of:
powering the compact self contained removable system by hydraulic fluid under pressure from the compact host vehicle.

13) The method of claim 11, further comprising the steps of:
Monitoring and controlling the compact self contained removable system within the compact host vehicle.

14) The method of claim 11, further comprising the steps of:
controlling the compact self contained removable system to allow an operator to choose between directing the water/foam/air mixture to the remotely operated nozzle or the manually operated firefighting hose.

15) The method of claim 11, further comprising the steps of:
removing the compact self contained removable system mounted on the skid support platform from the compact host vehicle when it is desired to use the compact host vehicle for different functions.
